(19) United States
(12) Patent Application Publication
(10) Pub. No.: US 2020/0345012 A1
(43) Pub. Date: Nov. 5, 2020

(54) SURFACE AND LAUNDRY DECONTAMINATION FORMULATION

(71) Applicant: DECON7 SYSTEMS, LLC, Scottsdale, AZ (US)

(72) Inventors: MATTHEW A. BLUHM, Winnetka, IL (US); BRIAN STARBUCK, Englewood, CO (US)

(73) Assignee: DECON7 SYSTEMS, LLC, Scottsdale, AZ (US)

(21) Appl. No.: 16/932,542

(22) Filed: Jul. 17, 2020

Related U.S. Application Data
(63) Continuation-in-part of application No. PCT/US19/14016, filed on Jan. 17, 2019.
Application No. PCT/US19/14016 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US18/37817 is a continuation-in-part of application No. PCT/US19/14018, filed on Jan. 17, 2019.
Application No. PCT/US19/14018 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US18/37817 is a continuation-in-part of application No. PCT/US19/14020, filed on Jan. 17, 2019.
Application No. PCT/US19/14020 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US18/37817 is a continuation-in-part of application No. PCT/US19/14023, filed on Jan. 17, 2019.
Application No. PCT/US19/14023 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US18/37817 is a continuation-in-part of application No. PCT/US19/14025, filed on Jan. 17, 2019.
Application No. PCT/US19/14025 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US18/37817 is a continuation-in-part of application No. PCT/US19/64558, filed on Dec. 4, 2019.
Application No. PCT/US19/64558 is a continuation-in-part of application No. PCT/US19/14016, filed on Jan. 17, 2019.
Application No. PCT/US19/14016 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US19/64558 is a continuation-in-part of application No. PCT/US19/14018, filed on Jan. 17, 2019.
Application No. PCT/US19/14018 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US19/64558 is a continuation-in-part of application No. PCT/US19/14020, filed on Jan. 17, 2019.
Application No. PCT/US19/14020 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US19/64558 is a continuation-in-part of application No. PCT/US19/14023, filed on Jan. 17, 2019.
Application No. PCT/US19/14023 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US19/64558 is a continuation-in-part of application No. PCT/US19/14025, filed on Jan. 17, 2019.
Application No. PCT/US19/14025 is a continuation-in-part of application No. 16/209,960, filed on Dec. 4, 2018.
Application No. 16/209,960 is a continuation of application No. PCT/US18/37817, filed on Jun. 15, 2018.
Application No. PCT/US19/64558 is a continuation of application No. 16/209,960, filed on Dec. 4, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.
(60) Provisional application No. 62/618,095, filed on Jan. 17, 2018.
(60) Provisional application No. 62/618,096, filed on Jan. 17, 2018.
(60) Provisional application No. 62/618,098, filed on Jan. 17, 2018.
(60) Provisional application No. 62/618,100, filed on Jan. 17, 2018.
(60) Provisional application No. 62/618,104, filed on Jan. 17, 2018.

(51) Int. Cl. A01N 59/00; A01N 33/12; A62D 3/38; A01N 25/02; A62D 3/00

(52) U.S. Cl. CPC A01N 59/00; A01N 33/12; A62D 2101/26; A01N 25/02; A62D 3/00; A62D 3/38

(57) ABSTRACT

An improved formulation may include an enhanced ability relative to its predicates to destroy toxic threats in the form of sporulated bacteria, bacteria protected by biofilms, planktonic bacteria, fungus, viruses, chemical weapons, toxic chemicals including Fentanyl, its analogs, and a whole host of toxic industrial chemicals. The formulation may include a three part product composed of a buffered detergent chemical system, a hydrogen peroxide chemical system and an accelerator system designed to deliver activated peroxygen species when blended together.

### CROSS-REFERENCE TO RELATED APPLICATIONS

This nonprovisional patent application claims priority to a PCT application number PCT/US19/64558, filed on Dec. 4, 2019; a PCT application number PCT/US19/14016, filed on Jan. 17, 2019; a PCT application number PCT/US19/14018, filed on Jan. 17, 2019; a PCT application number PCT/US19/14020, filed on Jan. 17, 2019, a PCT application number PCT/US19/14023, filed on Jan. 17, 2019, a PCT application number PCT/US19/14025, filed on Jan. 17, 2019, which claims priority to a nonprovisional application Ser. No. 16/209,960, filed on Dec. 4, 2018, which is a continuation of a PCT application number PCT/US18/37817, filed on Jun. 15, 2018, and claims priority to provisional application Ser. No. 62/618,095, filed on Jan. 17, 2018; a provisional application Ser. No. 62/618,096, filed on Jan. 17, 2018; a provisional application Ser. No. 62/618,098, filed on Jan. 17, 2018; a provisional application Ser. No. 62/618,100, filed on Jan. 17, 2018; and a provisional application Ser. No. 62/618,104, filed on Jan. 17, 2018; where the entire disclosures of the above identified applications are incorporated by reference herein.

Moreover, this nonprovisional patent application is related to U.S. Pat. Nos. 9,855,572, and 9,856,072; and U.S. Design Pat. Nos. D799,008, D822,163, and D822,164.

### TECHNICAL FIELD

Embodiments of the present invention relate to formulations for neutralization of chemical, biological and industrial toxins. In other embodiments, aspects of the present invention relate to formulations for the treatment of bacteria cocooned or protected by biofilms.

### BACKGROUND OF THE INVENTION

Prior art includes materials containing solubilizing compounds and reactive compounds that include at least two solubilizing compounds, wherein at least one solubilizing compound is a cationic surfactant and at least one solubilizing compound is a cationic hydrotrope. Also, the prior art compounds include at least one reactive compound is selected from the group consisting of hydrogen peroxide, urea hydrogen peroxide, hydroperoxycarbonate, peracetic acid, sodium perborate, sodium peroxypyrophosphate, sodium peroxysilicate, and sodium percarbonate; and at least one water-soluble bleaching activator selected from the group consisting of ethylene glycol diacetate, propylene glycol monomethyl ether acetate, methyl acetate, dimethyl glutarate, diethylene glycol monoethyl ether acetate, and propylene glycol diacetate, and combinations thereof. In one embodiment, at least two solubilizing compounds, at least one reactive compound, and at least one water-soluble bleaching activator are mixed with water and exposed to at least one toxant to neutralize one toxant.

The first necessity in decontamination is to facilitate exposure of the pathogen/agent/contaminant/toxin to the reactive mechanism designed to defeat it. On surfaces this necessitates:

inducing the ability to desorb a substance from the surface, or

enabling hydraulic mobility of the substance (displacement), or

forcing the substance into a hydraulically vulnerable state (dissolution)

A harmful substance may penetrate deeply into the reticulated grain structures of microscopic surfaces, making it difficult to displace. Simply using water or other solvent may not present the appropriate physiochemical environment sufficient to overcome the forces holding or shielding the substance in place.

However, improvements are desirable for treatment of toxic chemicals including Fentanyl, its analogs and a broader spectrum of nonpolar toxants. Further, improvements relating to the ability to disrupt, distort and destroy biofilms are desirable.

### SUMMARY

According to one embodiment, an improved formulation, to be abbreviated for the purpose of simplicity and to be referred to as “D7-2.0” includes an enhanced ability relative to its predicates to destroy toxic threats in the form of sporulated bacteria, bacteria protected by biofilms, planktonic bacteria, fungus, viruses, chemical weapons, toxic chemicals including Fentanyl, its analogs, and a whole host of toxic industrial chemicals. In one embodiment, D7 2.0 may include a three part product composed of a buffered detergent chemical system, a hydrogen peroxide chemical system and an accelerator system designed to deliver activated peroxygen species when blended together.

Embodiments of the invention describe an enhanced chemical formulation and manner of practice administering two predicate patented products (DF-200 and SSDX-12) designed for the decontamination, disinfection and renewal of surfaces exposed to chemical, biological, toxic industrial contaminants and residues. These two products are standalone treatments for decontamination strategies. The combinations of the two in concert with one another presents a unique approach to decontamination and disinfection strategies.

SSDX-12 is a high potency decontamination soap specifically used for the safe decontamination of air craft. In order to achieve that claim, SSDX-12 was required to demonstrate resistance to corrosion on aircraft metal alloys and sensitive equipment. The product was also required to remove residues of chemical weapons down to an acceptable standard. While the product is demonstrably effective at treating the targeted surfaces, the challenge of remediating the now dissolved and mobile chemical agents remained. In many situations it is simply unacceptable to rinse the treatment off into the environment.

D7 formula (hereinafter “D7” or “D7 formula”) is a high potency decontamination/disinfection agent used to treat surfaces contaminated with bacteria, viruses, mold, mildew, toxic industrial chemicals, chemical weapons and other pathogenic and harmful agents. D7 is able to promote the rapid chemical remediation of these threats by virtue of its unique ability to solubilize normally water insoluble targets and expose them to chemical oxidation directly or in the realm of a self assembled micellular structure embodied in the formula.

In one example, D7 formula extends the technology to include both oxidation reactions and reducing reactions. Additionally, D7 incorporates the treatment for toxic industrial chemicals. It also is the first reference to a bleaching activator.

In another example, D7 expands into the area of mold, disinfection and sterilization. The chemistry has not changed or been modified. In effect, D7 is closest to the utility the product enjoys today.

Moreover, D7 expands on the chemical landscape for DF-200. Additionally it incorporates data for rates of reaction against various toxic agents. It is also an improvement of the original DF-100 relative to performance against mustard agents in regard to reaction time and specificity. In one embodiment, D7 also integrates different bleaching activators.

The synergy of effectiveness of these two decontamination strategies is a step forward in the state of the art of decontamination and surface remediation providing a much needed improvement in these practices.

### BRIEF DESCRIPTION OF DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is an overview of decontamination formulation according to one embodiment.

FIG. 2 is a graph illustrating interfacial tension test results comparing a first formulation to an improved formulation according to one embodiment of the invention.

FIG. 3 is a graph illustrating a test result of drop volume versus time between a first formulation and an improved formulation according to one embodiment of the invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. The following detailed description may, therefore, not to be taken in a limiting sense.

In one embodiment, aspects of the invention include a three-part formulation that are provided below:

### Part 1. A Buffered Detergent Chemical System May Include

| Ingredient | % in formula |
|---|---|
| Generation 5 Quat | <10% |
| Hydrotrope | <10% |
| Surfactant blending, foam | 20 to 70 |
| stabilizing, cosolvent | |
| formulation system | |
| pH buffering system | 0.1 to 20 |
| Water | Balance |

In one embodiment, hydrotrope comprises Gen 6 Quat. In another embodiment, the surfactant system comprises one or more of the following: isobutyl alcohol, diethylene glycol monobutyl ether, propylene glycol, and lauryl alcohol. In another embodiment, the pH buffering system may include potassium bicarbonate, potassium carbonate, etc.

### Part 2. A Hydrogen Peroxide Chemical System May Include

| Ingredient | % in formula |
|---|---|
| Hydrogen peroxide | <20% |
| Stabilizer | <2% |
| Gettering agent | <2% |
| Water | Balance |

In one embodiment, the stabilizer may include phosphoric acid. In a further embodiment, the gettering agent may include a phosphonate salt.

### Part 3. An Accelerator System May Include

| Ingredient | % in formula |
|---|---|
| Accelerator | 100 |

In one embodiment, the accelerator system comprises diacetin.

Moreover, embodiments of the invention prepare the above three parts formulation in the following desirable proportions by volume or concentration:

Part 1 about <50%

Part 2 about <50%

Part 3 about <10%

In one embodiment, as a brief description, quaternary ammonium (“Quat”) are classified as:

### First Generation of Quaternary Ammonium (“Gen 1 Quat”)

Benzalkonium chloride, also known as nalquil dimethyl benzyl, wherein the alkyl chain can have variations in the composition of decarbonos number chloride. The alkyl chains of 12 and 14 carbons, are those with greater antibacterial power. This first generation emerged over 50 years ago, is the one with lowest since biocidal activity and has many years in the market for disinfection applications, there may be as bacterial resistance to the product. However, this molecule is still widely used in hospital and veterinary disinfection, bactericidal and deodorant use foot powders and topical disinfectants.

### Second Generation of Quaternary Ammonium (“Gen 2 Quat”)

Chemical name: of nalquil ethyl benzyl dimethyl ammonium chloride, that is, has an ethyl radical in the aromatic ring.

### Third Generation of Quaternary Ammonium (“Gen 3 Quat”)

The mixture of the first two generations of quaternary: benzalkonium chloride (1st Generation) chloride and alkyl dimethyl benzyl ammonium chloride (2nd Generation). The mixture of these two quaternary it have an increased biocidal activity, increased detergency and increased user safety by a relatively low toxicity. The use of the mixture helps to prevent bacterial resistance to continued use of a single molecule.

### Fourth Generation of Quaternary Ammonium (“Gen 4 Quat”)

They called “Twin or Dual Chain quats” or quaternary “twin chain” are quaternary products with linear dialkyl chains without benzene ring, such as didecyl dimethyl ammonium chloride or chloride, dioctyl dimethyl ammonium chloride or octyl decyl ammonium, each isolated. These quaternaries are superior in germicidal activity are low foaming and have a high tolerance to protein loads and hard water. Recommended for disinfection in food and beverage industry, because it can be applied by low toxicity.

### Fifth Generation of Quaternary Ammonium (“Gen 5 Quat”)

Mixture of the fourth generation with the second generation, that is, didecyl dimethyl ammonium chloride++alkyl dimethyl ammonium chloride, alkyl benzyl ammonium dimetiletilbencil+of other varieties according to the formulations.

In one embodiment, the formulation may maintain their activities described in prior art associated with the predicate relative to their ability to treat surfaces contaminated with Chemical Weapon (CW), Toxic Industrial Chemicals (TICs), Bacteriological Pathogens, Pathogenic Viruses afflicting human and animal hosts, Fungus and Mildew infestations and Biofilm forming bacteria colonies. Aspects of the invention may provide substantial improvement by virtue of their ability to reduce the interfacial tension relative to the predicate(s). In one embodiment, the interfacial tension reduction manifests itself by rapidly disrupting, distorting and destroying biofilms and consequently delivering pesticidal efficacy to the underlying colony(s). Additionally, embodiments of the invention improve over the prior technology in expanding the scope of toxant treatment efficacy by the same interfacial tension reduction mechanism which enables improved uptake of nonpolar toxants into the decontamination realm of the formulae.

In one embodiment, the formulation D7 2.0 is non-toxic, safe to use on human contact surfaces and suitable for sensitive food processing facilities. In another embodiment, D7 2.0 may be diluted to levels appropriate to the application (like no rinse mild table top sanitization where <400 ppm of sanitizing agent is sufficient for effect up to >16000 ppm for high level disinfection where sporulated and biofilm cocooned pathogens as well as highly dangerous CW are involved) and may be capable of retaining virucidal and bactericidal efficacy. In one embodiment, D7 2.0 may be applied by a delivery system such as the system for mixing and dispensing fluids disclosed in U.S. Pat. Nos. 9,855,572, and 9,856,072; and U.S. Design Pat. Nos. D799,008, D822,163, and D822,164, all assigned to the Applicant of the present application. These pesticidal efficacy claims are regulated by the Environmental Protection Agency under strict guidelines requiring adherence to standard microbiological methodology under the umbrella of Good Laboratory Practices.

In one example, some disinfection situations require a full strength application of the D7 2.0. Situations like surface decontamination or disinfection of highly soiled environments require a full strength dosage. In another embodiment, treatment of lightly soiled surfaces may only need a diluted version of the formula to achieve acceptable treatment (either disinfection or decontamination). Embodiments of the invention integrate a generation 5 quaternary amine package providing a broader efficacy spectrum for both disinfection and decontamination. One of the aspects of the invention may be that it may be easily modified or “throttled” to enable the efficient treatment of surfaces with variable surface energies.

D7 2.0 may be an aqueous based formulation with enhanced ability to rapidly treat surfaces afflicted with biological or organic chemical toxic threats. Those toxic threats may take the form of chemical agents, toxins or other substances which pose threat to human, animal or food supply health. In the case of chemical contamination, embodiments of the invention serve as a decontamination agent. Toxic threats from bacteriological sources (sporulated bacteria, biofilm encased bacteria, planktonic bacteria, viruses, fungi or mildew) are also targeted agents of these enhanced formulae in their form as a disinfectant.

A chemical or bacteriological contagion prescribes that time and destructive efficacies are the highest priorities to reduce the opportunity of proliferation of the contagion agent via aerosolization, dust lifting or other modes of spreading. As an example, in the case of encountering a potent chemical agent like Fentanyl or its derivatives, fast effective treatment (<5 minutes for 99.9% destruction) may be desirable to render the human occupied space safe for responders and occupants. Moreover, efficacy or speed of treatment may be measured in seconds up to minutes depending and varying with circumstances. For example, in the case of disinfection, a common efficacy timeframe may be 10 minutes. In one aspect, this timeframe is prescribed largely as a result of the expense involved in testing.

In one example, each time point tested might cost several thousand dollars to measure a result. In the case of decontamination, testing costs also limit time point studies. In one example, minutes may be the usual target. The speed performance of a disinfection or decontamination strategy is dependent upon: the physiochemical nature of the agent to be treated; the surface to be treated; or the amount of filth that needs to be overcome.

In one example, the theme that may play itself out in many circumstances where control of a toxic or pathogenic spread is necessary to assure safety of occupants (human or animal), food supply, husbandry facilities, human contact surfaces, health care facilities, etc. It may be difficult to apply mechanical disruption to affected surfaces due to their inaccessibility to human reach or the desire to not disturb potentially hazardous substances. Therefore, chemical potency may called on to react with threats to eliminate them. In one example, the complex surfaces and hidden areas beyond human reach may be numerous in facilities where sanitization is critical. Chemical treatment may be the only means by which sanitization potency can be delivered. It is very difficult to apply mechanical disruption force to every critical surface. Recent fatal bacteria borne outbreaks emphasized the fact that equipment sanitization was a possible vector in spreading of listeria.

In all cases, the agent(s) causing the fatal demise of the pathogenic target must come into reactive proximity of the pathogen or toxin. In this example, it may mean molecular dimension proximity. If a substance is not in the same physical state at the decontamination agent, neutralization may become less likely. Gases permeate many areas but are problematic in practice. For a liquid to be effective, it must be able to solubilize a toxant or be able intimately contact a pathogen.

In one prior technology, predicate versions of DF200 were invented for the rapid and complete treatment of surfaces contaminated with CW or TICs. However, it was not until later that the disinfection efficacy activity of the predicate formulae was applied to biota. For example, some prior technology focuses on efficacy directed to chemical warfare agents or threats. However, no or little focus has placed on the efficacy of killing bacteria or viruses when treating different surfaces. Numerous pesticidal claims have been recognized by the EPA for formulary variants of DF200.

These cidal claims were essential to bringing the potency of DF200 to critical markets where biotic contagion threatens human beings and operations essential to the general welfare. It was quickly realized that planktonic bacteria destruction was one level of treatment needed for surface treatment, which DF200 lacks. Current methods designed for assessment of disinfectant efficacy focus on planktonic (free floating or nonaggregated) bacteria. The progressive threat of biota encased in biofilms represented an elevated and persistent problem afflicting sensitive operations where pathogenic outbreaks mays cause significant harm to people, essential food supplies and other critical areas essential for the general welfare. Standard disinfection strategies failed to treat the issue. This failure is primarily due to the fact that most disinfectants do not efficiently penetrate the nonpolar biofilm protective layer. DF200 predicates were evaluated against biofilm protected pathogens and its efficacy was demonstrated.

In one embodiment, the essential performance metric for assessing the formulae D7 2.0 may include interfacial tension (IFT). IFT is the force exerted by a liquid in contact with a solid or another liquid. In treating a surface, the IFT between the contaminant and the surface must be overcome to clean the surface. When a biofilm gains a foothold on a surface, both the biofilm/surface interface and the cohesive forces holding the biofilm together must be disrupted to effectively treat the contagion.

Biofilms are surfaces that may be naturally water repellent. To disrupt them, a treatment must be able to hydraulically pry its way into the biofilm matrix. In one example, biofilms may be composed of a complex series of chemicals including proteins, polysaccharides and other chemicals that coagulate together and are designated as “EPS”, Extracellular Polymeric Substances. The EPS layer may be hydrophobic (repels water) in nature and thus naturally may be resistant to water based disinfectants. The biofilm itself may be resistant to chemical treatments targeting pathogens embodied in the film by resisting penetration into its matrix. This behavior has been actively studied and documented by numerous researchers.

In one embodiment, to eradicate the pathogenic bacteria protected by the biofilm, both adhesive and cohesive forces must be overcome. The principles defining this interaction translate also into the area of decontamination in that the adhesive forces holding a toxin onto a surface must be overcome to facilitate removal and eventual destruction. Adhesive forces may be categorized by, for example, many different types of interactions. In one aspect, the net adhesive force may be the sum of forces that enable a substance to stick to a surface. In another example, a surface may include a particular affinity for different substances. In the example, the forces that keep a contaminant on a surface (therefore in a state of threat) may be overcome to move it to the realm where it may then react in solution with the activated chemistry induced by the presence of hydrogen peroxide or be rinsed away. D7 2.0 described below may target, in one embodiment, the modulation of these forces in a way that is unique and not obvious and produce unexpected results.

### EXAMPLE 1

### Experiment 1

Modification of interfacial tension characteristics of the D7 2.0 may be the essence of the invention. As provided above, interfacial tension is the force that must be overcome between the barrier separating two immiscible phases. The principles underlying this behavioral property are well documented. In one embodiment, the lower the interfacial tension, the more vulnerable the interface is to the penetration of water and the reactive activated oxygen species germane to the formulation. As an example, in experiment 1, a drop of beef grease in contact with water will not be dissolved and will remain intact indefinitely for all intent and purposes. The interfacial tension between beef grease and water may be about 20 to 30 millinewton/meter (mN/m). The x-axis represents time after grease drop formation in minutes.

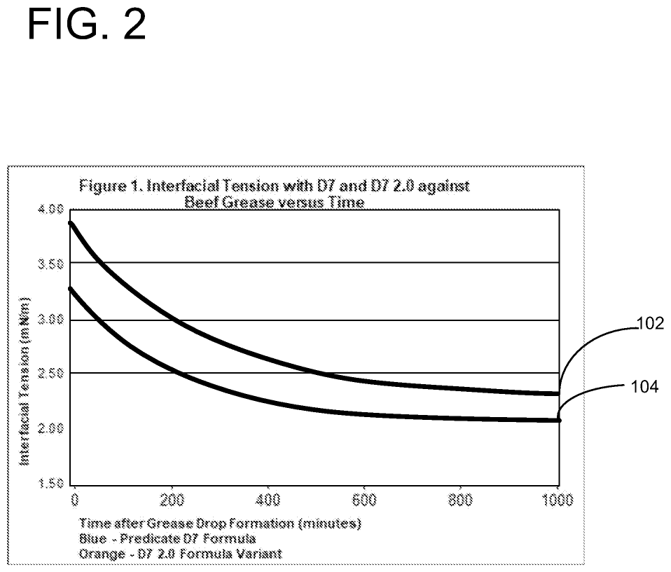

In this experiment, the beef grease proxy was then exposed to the D7 predicate 102 and D7 2.0 variant 104, where the D7 predicate 102 may not include the mixture of D7 2.0. The plot illustrated in FIG. 2 may demonstrate the reduction of interfacial tension of D7 2.0 in contact with beef grease based on the line 104. Also illustrated on the plot is the interfacial tension of the D7 predicate in contact with the same beef grease proxy. The initial interfacial tension in both cases renders the beef grease vulnerable. The generation 5 (gen 5) variant in D7 2.0, according to this embodiment, may show a greater proclivity for surface tension reduction than the variant. This fact demonstrates a potent and non obvious benefit for treatment of hydrophobic surfaces and toxants using the D7 2.0 formulation.

### EXAMPLE 2

### Experiment 2

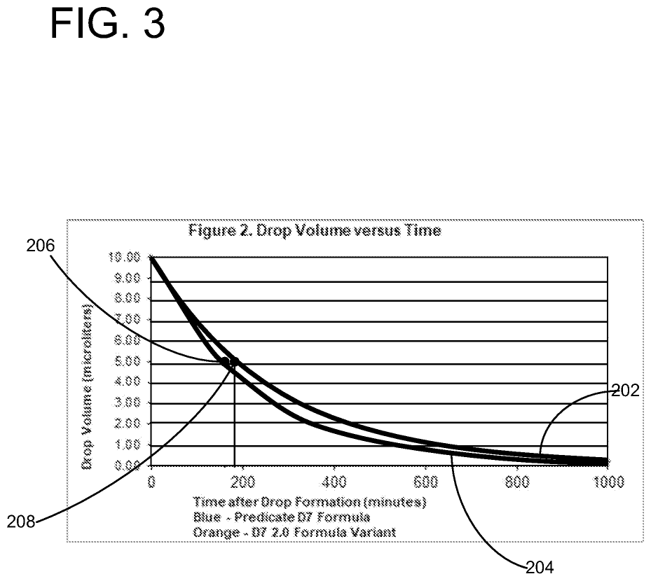

Surface chemistry modification measurement may be achieved by employing a proprietary surface chemistry Pendant drop analysis method that may measure the volume and shape of a defined droplet versus time reckoned from initial exposure to the test formulation. This measurement may utilize a sophisticated imaging technique that continuously calculates the pendant drop volume and shape. The time to achieve 50% of the initial drop volume is one of the performance figures of merit which was noted and compared to different formulation variants. A typical plot result is shown in FIG. 3.

In one embodiment, the shift of the curve to the left upon exposure to the D7 2.0 variant may indicate a more rapid cleaning action. The t_{1/2} volume time was 157 minutes at 206 for the D7 2.0 variant compared to 185 minutes at 208 for the D7 predicate. This represents a 15% improvement in decontamination performance relative to the predicate.

In one embodiment, this interfacial tension problem is one of the reasons biofilms are resistant to standard disinfectants. The surface of the biofilm are non polar in a manner similar to that of beef grease and behaves in such a way as to repel aqueous based disinfectants. In another embodiment, D7 and to a greater extent D7 2.0 may reduce the interfacial tension energy barrier present between immiscible layers. In one example, biofilm protected colonies were cultured and exposed to the D7 predicate and D7 2.0 variant. The biofilm protected colony was enumerated at 8.736=log₁₀[CFU/cm²]. Following treatment with the predicate D7 formula, a 5.2 log reduction of bacteria was measured. Following treatment with the D7 2.0 variant formula, an 8.7 log reduction of bacteria was measured. In one aspect, this may complete eradication of the biofilm protected colony. Moreover, this experiment further demonstrates the improved efficacy of the D7 2.0 variant over the D7 predicate.

In addition, D7 2.0 has been approved as a disinfectant or sanitizer pesticide against;

Staphylococcus aureus [(ATCC 6538)] [Staph]

Salmonella enterica [(ATCC 10708)] [Salmonella]

Pseudomonas aeruginosa [(ATCC 15142)]

Avian Influenza A (H3N2) Reassortant Virus

Avian Influenza A (H5N1) Virus

Avian Influenza A (H7N9) Virus

Porcine Epidemic Diarrhea Virus

Listeria monocytogenes [(ATCC 15313)]

Escherichia coli [(ATCC 11229)]

### EXAMPLE 3

### SSDX at 15:1

SSDX-12 is designed to achieve a safe, environmentally benign, low regret physiochemical agency capable of enabling conditions favorable toward the removal or deshielding of pathogens/agents/contaminant/toxins. With the application of SSDX-12, the offending substance can be hydraulically removed or rendered hydraulically vulnerable.

In one example, the SSDX-12 may include a cleaning composition such as a C.sub.8-22 alkyl dimethylamine oxide surfactant, a C.sub.6-12 alkyl dimethylamine oxide surfactant, a C.sub.8-18 alkyl polyethylene glycol sorbitan fatty ester surfactant, and a C.sub.12-14 secondary alcohol ethoxylate surfactant. The C.sub.8-18 alkyl polyethylene glycol sorbitan fatty ester surfactant includes from 0 to about 20 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule.

In yet another embodiment, a cleaning composition for cleaning exterior surfaces of a vehicle is provided. The cleaning composition includes from about 0.1% to about 5% by weight of a C.sub.8-16 alkyl dimethylamine oxide surfactant, from about 0.1% to about 5% by weight of a C.sub.6-10 alkyl dimethylamine oxide surfactant, from about 0.1% to about 5% by weight of a C.sub.10-14 alkyl polyethylene glycol sorbitan fatty ester surfactant, and from about 0.1% to about 5% by weight of a C.sub.12-14 secondary alcohol ethoxylate surfactant including from about 14 to about 16 ethoxylate groups per C.sub.12-14 secondary alcohol ethoxylate surfactant molecule. The C.sub.10-14 alkyl polyethylene glycol sorbitan fatty ester surfactant includes from 0 to about 6 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule. The C.sub.8-16 alkyl dimethylamine oxide surfactant, the C.sub.6-10 alkyl dimethylamine oxide surfactant, the C.sub.10-14 alkyl polyethylene glycol sorbitan fatty ester surfactant, and the C.sub.12-14 secondary alcohol ethoxylate surfactant are provided in a 1:1:1:1 ratio in the cleaning composition. The cleaning composition is effective to remove chemical warfare agents from the exterior surfaces of the vehicle upon application thereto.

In one application, a method for cleaning exterior surfaces of a vehicle using the above cleaning composition may be applied. The method includes providing a cleaning composition, applying the cleaning composition to the exterior surfaces of the vehicle, and rinsing the exterior surfaces of the vehicle with water.

However, once displaced from its microscopic perch, substances may then be exposed to the reactive spectrum (photoelectric radiation, oxidation, chemical modification by an external substance) that facilitates its chemical transformation. In other words, the fact that SSDX-12 was able to be applied as a cleaning composition to a surface of a vehicle, for example, does not mean the dissolved solution is not toxic or environmentally friendly. That is to say, in this state, a toxin becomes highly vulnerable to natural forces which promote its inevitable tumble to its lowest energy state.

A concrete surface may look solid from our perspective but when viewed microscopically, it can consist of a complex network of pathways. This is the same with any porous surface. Close inspection reveals a labyrinth in many cases. Delivering chemistry into this microscopic environment requires that significant surface tension forces be overcome. Surface tension is the property of a liquid that defines how it spreads out on a surface and how well it will penetrate into a surface. The proprietary formulation elements of D7 enable very low surface tension values to be obtained at a surface. These values are not equilibrium values but rather, dynamic values. A turbulent solution, made so by the effervescence of decomposing hydrogen peroxide, will continuously be refreshing itself at the leading edges of its penetration into a surface. These transient ultra-low surface tension values enable a deeper penetration of the active chemistry embodied in D7. The cationic quaternary amine surfactants, coupled with the alkaline pH carbonated buffer system lay the pathway for a more effective penetrating delivery of the complex cleaning chemistry embodied in D7. The product behaves in ways similar to the mechanisms behind hydraulic fracturing without the high pressure pumps.

Alkali carbonates (potassium based) interact with the predominantly negatively biased surface

Quaternary amines adsorb strongly onto that negatively biased surface

Hydraulic channels are opened allowing delivery of the cleaning power in the form of water, peroxide, and other formulation nonionic species.

In its ability to penetrate/eradicate biofilms vs. traditional forms, D7 provides advantages over prior technologies as well. In one example, biofilms are comprised of a secreted chemical matrix that protects pathogen colonies from intruding threats. These films have nutrient causeways, respiration causeways and transpiration causeways and their precise nature is the subject of intense inquiry. The physiochemical solution properties of D7 interact in such a way as to efficiently and thoroughly disrupt those surfaces. The solvency properties and the oxidation from peroxide and peracetic acid species effectively “pry” open the surface of the film and in some cases aid in the defeat of the functional causeways resulting in terminal disruption. Biofilms effectively organize water in a secreted extracellular matrix that in many cases are disrupted by the D7 detergency mechanisms.

Embodiments of D7 describe an enhanced chemical formulation designed for the decontamination, disinfection and renewal of surfaces exposed to chemical, biological and toxic industrial contaminants and residues. This formula improves on prior art by expanding the efficacy spectrum, decreasing treatment time, modifying chemical properties allowing for lower effective dosage and broadening the roster of chemical agents remediated by it. The formulation described herein may also be applied in variable concentrations to achieve decontamination objectives (cleaning, sanitization, disinfection, high level disinfection, mold remediation, biofilm remediation, targeted decontamination).

Embodiments of D7 aim to incremental variants designed to perform particular tasks is the intent of this effort. In one embodiment, aspects of the invention may be formulated with a Generation 1 version of Quaternary amine (ADBAC). It is thought that broadening the type of quaternary amine may bring a benefit in either efficacy against a broader range pathogens or greater effectiveness against biofilms. Of the two, biofilm effectiveness is likely the prominent value proposition.

Furthermore, D7 provides a simple roster of ingredients. D7 is not made of exotic ingredients. It is assembled with common, benign, readily available materials. Their combination produces a net effect greater than the simple sum of each.

The physical properties embodied in D7 tell part of the story of its success. Things like dynamic surface tension, critical micelle concentration, micellar aggregation number, solvolytic potential and solution polarity all contribute to the enigmatic behavior of D7.

One of the more compelling actions of D7 arises from the micelle formations. These micelles act as miniature reaction factories where toxicants react with activated oxygen species rendering them neutralized or harmless.

As a starting point, the application of D7 in response to biofilm issues seems a valued efficacy for the customer. Defeating a biofilm protected bacteria colony virtually insures defeat of the prokaryotic bacteria itself. The roster of efficacy of D7 in relation to various organisms is listed below:

Disinfection Efficacy

| | | |
|---|---|---|
| Eschericia Coli | Listeria Monocytogenes | Staphylococcus Aureus |
| | | (MRSA, VRSA) |
| Klebsiella pneumoniae | Stereptococcus | Enterobacter cloacae |
| | epidermidis | |

Taking a view of the relationship of the quat generation, the following comparison is relevant.

Generation 5 Quaternary Amine. This category is a mixture of generation 1 and generation 4. The innovation options can rapidly multiply when one considers permutations of different generation 1 chemistries along with the generation 4 variants. In one embodiment, D7 formulation includes:

| Vendor | Product | Description | Notes |
|---|---|---|---|
| Stepan | BTC-1210 | 80% Active | Different foaming characteristics, |
| | | 32% CAS 68424-85-1 | different efficacy profile, different |
| Pilot | Maquat | 48% CAS 7173-51-5 | physiochemical performance, |
| | 2420-80% | | enhanced biofilm defeat efficacy, |
| | | | residual sanitation performance |
| Stepan | BTC-888 | 80% Active | Different foaming characteristics, |
| | | 32% CAS 68424-85-1 | different efficacy profile, different |
| Pilot | MQ-624M | 48% Variable dialkyl, dimethyl | physiochemical performance |

| Part A Formulation Ingredient | Prescribed amount |
|---|---|
| BTC 888 (80% active) 32% (40% C12, 50% C14, 10% C16) + 48% | 0.1 to 4.00% |
| DADMAC | |
| Octyl Decyl Dimethyl Ammonium Chloride (24%) MW = 334.0273 | 0.024 to 0.960% |
| Di-n-Octyl Ammonium Chloride (12%) MW = 270.5207 | 0.012 to 0.480% |
| Di-n-Decyl Ammonium Chloride (12%) MW = 326.6279 | 0.012 to 0.480% |
| ADBAC C12 (40%) MW = 339.9909 | 0.0128 to 0.512% |
| ADBAC C14 (50%) MW = 368.0445 | 0.016 to 0.640% |
| ADBAC C16 (10%) MW = 396.0981 | 0.0032 to 0.128% |
| Adogen 477D (50% Active) | 0.05 to 2.00% |
| Glycol Ether DB | 0.4 to 1.60% |
| Isobutanol | 0.025 to 1.00% |
| Propylene Glycol | 0.5 to 20.00% |
| Lauryl Alcohol | 0.02 to 0.80% |
| Potassium Bicarb USP Anhyd | 0.3 to 12.00% |
| Caustic Potash | 0.0425 to 1.70% |
| Water | 56.90 to 98.56% |
| Part B Formulation Ingredient | Prescribed amount |
| Hydrogen peroxide | 0.2 to 8.00% |
| Inerts and stabilizers | |
| Water | 99.8 to 85% |
| Part C Formulation Ingredient | Prescribed amount |
| Bleaching accelerator | 0.05 to 2.00% |

In one embodiment, the Generation 5 surfactants and dimethyl dialkyl quaternary amines present an enhanced structure to the micelles developed in the D7 formulation.

These surfactants may modify the Gouy-Chapman-Stern layer to the point of enhanced and improved ability to more rapidly solubilize agents into the micelle body.

In one example, the surfactants may modify the Gouy-Chapman-Stern layer that may be tied to the speed at which an agent is decontaminated, or it might be the extent of its decontamination.

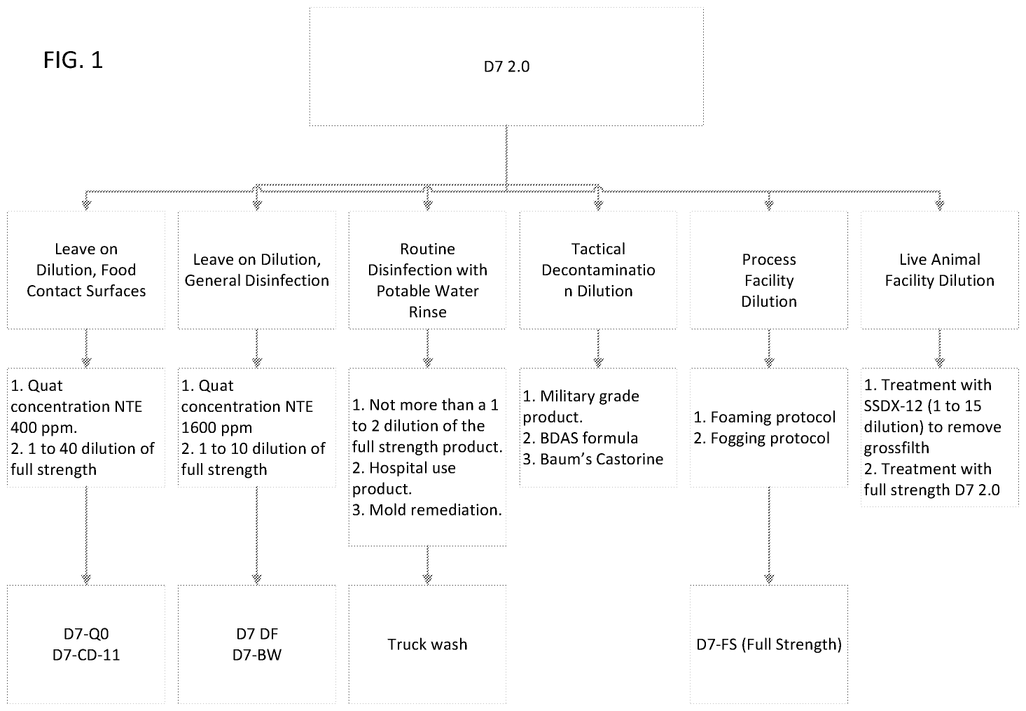

This embodiment of the invention may have different physical properties. The efficacy profile of this version will also be different. The development of the efficacy profile should be from a dilute version, perhaps a 1 to 100 dilution of the final product, up to the full version. The dilute version might be considered for surfaces that are already clean and devoid of biofilm presence. In one embodiment, the concentrated version would be considered for circumstances where gross filth is more prevalent (live animal facilities, processing plants, high biofilm potential places). Various embodiments of the invention for different dilutions (bacteria, biofilm, fogging efficacy) may enable various levels of applications in addition to those disclosed in FIG. 1.

This improvement upon prior art enables the contemplation of a full spectrum product capable of dealing with sensitive cleaning and sanitization situations like those encountered in food contact circumstances. In those circumstances, a product may be able to be applied to a target surface usually as a spray and wiped down distributing the cleaning/sanitization formulation over the entire surface. In one embodiment, aspects of the invention may need to receive approval from regulatory oversight agencies before use. In this case, this is commonly known as a “leave-on” product. There are statutory limits of labeled ingredients permissible for this type of use. It is an embodied intention of this improvement to enable this type of use. A full strength version of the product is intended for use in highly compromised environments like live animal barns where significant gross filth is anticipated. This represents the other end of the product spectrum. Regulatory oversight is also a requisite in relation to pesticidal embodiments. It is anticipated that there will be many situations in between these two extremes where a strength modulated product would serve the need. Examples of such situations are given in spectrum above.

It is often necessary to promote a speedier transition to a less harmful state. Pathogens, toxic industrial chemicals, or other undesirable substances exist unchallenged in ambient environments except by those reactive agents common to their surroundings. The natural remedies for treatment of infestations include predation by organisms, hydrolysis by water, photolysis by electromagnetic radiation, absorption by the substrate and shielding of the pathogen by environmental film to name a few. If a pathogen is soluble in water, a simple rinse may suffice. The kinetic time frame for these actions can range from the immediate to very long periods of slow transition. Delivering reactive chemical activity in the form of oxidation or nucleophillic substitution is an effective treatment strategy well known in common practice. It is the route by which numerous agents deliver their efficacious dose. Once a substance is oxidized, it is generally more susceptible to environmental decay via one or more of the aforementioned mechanisms. Delivering oxidation activity to a target is not always straight forward. The use of bleach for instance is a common practice in many areas for disinfection and decontamination. Bleach is a water based solution whose ability to penetrate and engage pathogens is limited to the physiochemical barriers embodied on the substrate being treated. If the active cidal agent cannot come into reactive proximity with the target pathogen, nothing will happen. For this reason, disinfection and decontamination agents are formulated with substances that enable the ability overcome physiochemical barriers of interfacial tension and surface energy to deliver substances to reactive proximity. Additionally, substances that are not soluble in water may not be vulnerable to reaction based on the limited exposure to reactive conditions.

D7, as illustrated above, is a formula which overcomes physiochemical barriers to deliver reactive oxidation species to pathogenic targets and by virtue of its design, aid in the ability to bring resistant substances into solution where they are then vulnerable to oxidation by the mechanisms embodied in D7. This new version of the formula is an enhancement of previous versions and demonstrates a more robust and effective ability to perform decontamination/disinfection tasks. By alteration of the surfactant characteristics of the formula, we are able to show faster decontamination times and more complete defeat of protective pathogenic layers leading to better remediation results.

D7 is a decontamination agent that delivers chemical oxidation energy in a safe, dilute form for the purpose of promoting oxidation of toxins to less harmful or totally benign breakdown products. D7 chemically treats toxins by promoting oxidation and by consequence speeding up the decontamination process. By itself, D7 will work to promote decontamination. The application of SSDX-12 before D7 enhances the net effect by enabling of the displacement of adsorbed substances.

In one embodiment, the ratio of 15:1 equivalent dosage of D7 with SSDX-12 is desirable to achieve the targeted results with the right properties and effects on surface decontamination.

In one embodiment, the SSDX formulation may include an improved process for decontamination of surfaces using a tiered approach based on D7 formula having pathogen/agent/toxin mobilization followed by pathogen/agent/toxin destruction on the surface, wherein the D7 formula has SSDX-12 added with a ratio of 15:1 equivalent dosage.

### EXAMPLE 4

### SSDX 30:1

SSDX-12 is designed to achieve a safe, environmentally benign, low regret physiochemical agency capable of enabling conditions favorable toward the removal or deshielding of pathogens/agents/contaminant/toxins. With the application of SSDX-12, the offending substance can be hydraulically removed or rendered hydraulically vulnerable.

In one example, the SSDX-12 may include a cleaning composition such as a C.sub.8-22 alkyl dimethylamine oxide surfactant, a C.sub.6-12 alkyl dimethylamine oxide surfactant, a C.sub.8-18 alkyl polyethylene glycol sorbitan fatty ester surfactant, and a C.sub.12-14 secondary alcohol ethoxylate surfactant. The C.sub.8-18 alkyl polyethylene glycol sorbitan fatty ester surfactant includes from 0 to about 20 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule.

In yet another embodiment, a cleaning composition for cleaning exterior surfaces of a vehicle is provided. The cleaning composition includes from about 0.1% to about 5% by weight of a C.sub.8-16 alkyl dimethylamine oxide surfactant, from about 0.1% to about 5% by weight of a C.sub.6-10 alkyl dimethylamine oxide surfactant, from about 0.1% to about 5% by weight of a C.sub.10-14 alkyl polyethylene glycol sorbitan fatty ester surfactant, and from about 0.1% to about 5% by weight of a C.sub.12-14 secondary alcohol ethoxylate surfactant including from about 14 to about 16 ethoxylate groups per C.sub.12-14 secondary alcohol ethoxylate surfactant molecule. The C.sub.10-14 alkyl polyethylene glycol sorbitan fatty ester surfactant includes from 0 to about 6 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule. The C.sub.8-16 alkyl dimethylamine oxide surfactant, the C.sub.6-10 alkyl dimethylamine oxide surfactant, the C.sub.10-14 alkyl polyethylene glycol sorbitan fatty ester surfactant, and the C.sub.12-14 secondary alcohol ethoxylate surfactant are provided in a 1:1:1:1 ratio in the cleaning composition. The cleaning composition is effective to remove chemical warfare agents from the exterior surfaces of the vehicle upon application thereto.

In one application, a method for cleaning exterior surfaces of a vehicle using the above cleaning composition may be applied. The method includes providing a cleaning composition, applying the cleaning composition to the exterior surfaces of the vehicle, and rinsing the exterior surfaces of the vehicle with water.

However, once displaced from its microscopic perch, substances may then be exposed to the reactive spectrum (photoelectric radiation, oxidation, chemical modification by an external substance) that facilitates its chemical transformation. In other words, the fact that SSDX-12 was able to be applied as a cleaning composition to a surface of a vehicle, for example, does not mean the dissolved solution is not toxic or environmentally friendly. That is to say, in this state, a toxin becomes highly vulnerable to natural forces which promote its inevitable tumble to its lowest energy state.

A concrete surface may look solid from our perspective but when viewed microscopically, it can consist of a complex network of pathways. This is the same with any porous surface. Close inspection reveals a labyrinth in many cases. Delivering chemistry into this microscopic environment requires that significant surface tension forces be overcome. Surface tension is the property of a liquid that defines how it spreads out on a surface and how well it will penetrate into a surface. The proprietary formulation elements of D7 enable very low surface tension values to be obtained at a surface. These values are not equilibrium values but rather, dynamic values. A turbulent solution, made so by the effervescence of decomposing hydrogen peroxide, will continuously be refreshing itself at the leading edges of its penetration into a surface. These transient ultra-low surface tension values enable a deeper penetration of the active chemistry embodied in D7. The cationic quaternary amine surfactants, coupled with the alkaline pH carbonated buffer system lay the pathway for a more effective penetrating delivery of the complex cleaning chemistry embodied in D7. The product behaves in ways similar to the mechanisms behind hydraulic fracturing without the high pressure pumps.

Alkali carbonates (potassium based) interact with the predominantly negatively biased surface

Quaternary amines adsorb strongly onto that negatively biased surface

Hydraulic channels are opened allowing delivery of the cleaning power in the form of water, peroxide, and other formulation nonionic species.

In its ability to penetrate/eradicate biofilms vs. traditional forms, D7 provides advantages over prior technologies as well. In one example, biofilms are comprised of a secreted chemical matrix that protects pathogen colonies from intruding threats. These films have nutrient causeways, respiration causeways and transpiration causeways and their precise nature is the subject of intense inquiry. The physiochemical solution properties of D7 interact in such a way as to efficiently and thoroughly disrupt those surfaces. The solvency properties and the oxidation from peroxide and peracetic acid species effectively “pry” open the surface of the film and in some cases aid in the defeat of the functional causeways resulting in terminal disruption. Biofilms effectively organize water in a secreted extracellular matrix that in many cases are disrupted by the D7 detergency mechanisms.

Embodiments of D7 describe an enhanced chemical formulation designed for the decontamination, disinfection and renewal of surfaces exposed to chemical, biological and toxic industrial contaminants and residues. This formula improves on prior art by expanding the efficacy spectrum, decreasing treatment time, modifying chemical properties allowing for lower effective dosage and broadening the roster of chemical agents remediated by it. The formulation described herein may also be applied in variable concentrations to achieve decontamination objectives (cleaning, sanitization, disinfection, high level disinfection, mold remediation, biofilm remediation, targeted decontamination).

Embodiments of D7 aim to incremental variants designed to perform particular tasks is the intent of this effort. In one embodiment, aspects of the invention may be formulated with a Generation 1 version of Quaternary amine (ADBAC). It is thought that broadening the type of quaternary amine may bring a benefit in either efficacy against a broader range pathogens or greater effectiveness against biofilms. Of the two, biofilm effectiveness is likely the prominent value proposition.

Furthermore, D7 provides a simple roster of ingredients. D7 is not made of exotic ingredients. It is assembled with common, benign, readily available materials. Their combination produces a net effect greater than the simple sum of each.

The physical properties embodied in D7 tell part of the story of its success. Things like dynamic surface tension, critical micelle concentration, micellar aggregation number, solvolytic potential and solution polarity all contribute to the enigmatic behavior of D7.

One of the more compelling actions of D7 arises from the micelle formations. These micelles act as miniature reaction factories where toxicants react with activated oxygen species rendering them neutralized or harmless.

As a starting point, the application of D7 in response to biofilm issues seems a valued efficacy for the customer. Defeating a biofilm protected bacteria colony virtually insures defeat of the prokaryotic bacteria itself. The roster of efficacy of D7 in relation to various organisms is listed below:

Disinfection Efficacy

| | | |
|---|---|---|
| Eschericia Coli | Listeria Monocytogenes | Staphylococcus Aureus |
| | | (MRSA, VRSA) |
| Klebsiella pneumoniae | Stereptococcus | Enterobacter cloacae |
| | epidermidis | |

Taking a view of the relationship of the quat generation, the following comparison is relevant.

Generation 5 Quaternary Amine. This category is a mixture of generation 1 and generation 4. The innovation options can rapidly multiply when one considers permutations of different generation 1 chemistries along with the generation 4 variants. In one embodiment, D7 formulation includes:

| Vendor | Product | Description | Notes |
|---|---|---|---|
| Stepan | BTC-1210 | 80% Active | Different foaming characteristics, |
| | | 32% CAS 68424-85-1 | different efficacy profile, different |
| Pilot | Maquat | 48% CAS 7173-51-5 | physiochemical performance, |
| | 2420-80% | | enhanced biofilm defeat efficacy, |
| | | | residual sanitation performance |
| Stepan | BTC-888 | 80% Active | Different foaming characteristics, |
| | | 32% CAS 68424-85-1 | different efficacy profile, different |
| Pilot | MQ-624M | 48% Variable dialkyl, dimethyl | physiochemical performance |

| Part A Formulation Ingredient | Prescribed amount |
|---|---|
| BTC 888 (80% active) 32% (40% C12, 50% C14, 10% C16) + 48% | 0.1 to 4.00% |
| DADMAC | |
| Octyl Decyl Dimethyl Ammonium Chloride (24%) MW = 334.0273 | 0.024 to 0.960% |
| Di-n-Octyl Ammonium Chloride (12%) MW = 270.5207 | 0.012 to 0.480% |
| Di-n-Decyl Ammonium Chloride (12%) MW = 326.6279 | 0.012 to 0.480% |
| ADBAC C12 (40%) MW = 339.9909 | 0.0128 to 0.512% |
| ADBAC C14 (50%) MW = 368.0445 | 0.016 to 0.640% |
| ADBAC C16 (10%) MW = 396.0981 | 0.0032 to 0.128% |
| Adogen 477D (50% Active) | 0.05 to 2.00% |
| Glycol Ether DB | 0.4 to 1.60% |
| Isobutanol | 0.025 to 1.00% |
| Propylene Glycol | 0.5 to 20.00% |
| Lauryl Alcohol | 0.02 to 0.80% |
| Potassium Bicarb USP Anhyd | 0.3 to 12.00% |
| Caustic Potash | 0.0425 to 1.70% |
| Water | 56.90 to 98.56% |
| Part B Formulation Ingredient | Prescribed amount |
| Hydrogen peroxide | 0.2 to 8.00% |
| Inerts and stabilizers | |
| Water | 99.8 to 85% |
| Part C Formulation Ingredient | Prescribed amount |
| Bleaching accelerator | 0.05 to 2.00% |

In one embodiment, the Generation 5 surfactants and dimethyl dialkyl quaternary amines present an enhanced structure to the micelles developed in the D7 formulation.

These surfactants may modify the Gouy-Chapman-Stern layer to the point of enhanced and improved ability to more rapidly solubilize agents into the micelle body.

In one example, the surfactants may modify the Gouy-Chapman-Stern layer that may be tied to the speed at which an agent is decontaminated, or it might be the extent of its decontamination.

This embodiment of the invention may have different physical properties. The efficacy profile of this version will also be different. The development of the efficacy profile should be from a dilute version, perhaps a 1 to 100 dilution of the final product, up to the full version. The dilute version might be considered for surfaces that are already clean and devoid of biofilm presence. In one embodiment, the concentrated version would be considered for circumstances where gross filth is more prevalent (live animal facilities, processing plants, high biofilm potential places). Various embodiments of the invention for different dilutions (bacteria, biofilm, fogging efficacy) may enable various levels of applications in addition to those disclosed in FIG. 1.

This improvement upon prior art enables the contemplation of a full spectrum product capable of dealing with sensitive cleaning and sanitization situations like those encountered in food contact circumstances. In those circumstances, a product may be able to be applied to a target surface usually as a spray and wiped down distributing the cleaning/sanitization formulation over the entire surface. In one embodiment, aspects of the invention may need to receive approval from regulatory oversight agencies before use. In this case, this is commonly known as a “leave-on” product. There are statutory limits of labeled ingredients permissible for this type of use. It is an embodied intention of this improvement to enable this type of use. A full strength version of the product is intended for use in highly compromised environments like live animal barns where significant gross filth is anticipated. This represents the other end of the product spectrum. Regulatory oversight is also a requisite in relation to pesticidal embodiments. It is anticipated that there will be many situations in between these two extremes where a strength modulated product would serve the need. Examples of such situations are given in spectrum above.

It is often necessary to promote a speedier transition to a less harmful state. Pathogens, toxic industrial chemicals, or other undesirable substances exist unchallenged in ambient environments except by those reactive agents common to their surroundings. The natural remedies for treatment of infestations include predation by organisms, hydrolysis by water, photolysis by electromagnetic radiation, absorption by the substrate and shielding of the pathogen by environmental film to name a few. If a pathogen is soluble in water, a simple rinse may suffice. The kinetic time frame for these actions can range from the immediate to very long periods of slow transition. Delivering reactive chemical activity in the form of oxidation or nucleophillic substitution is an effective treatment strategy well known in common practice. It is the route by which numerous agents deliver their efficacious dose. Once a substance is oxidized, it is generally more susceptible to environmental decay via one or more of the aforementioned mechanisms. Delivering oxidation activity to a target is not always straight forward. The use of bleach for instance is a common practice in many areas for disinfection and decontamination. Bleach is a water based solution whose ability to penetrate and engage pathogens is limited to the physiochemical barriers embodied on the substrate being treated. If the active cidal agent cannot come into reactive proximity with the target pathogen, nothing will happen. For this reason, disinfection and decontamination agents are formulated with substances that enable the ability overcome physiochemical barriers of interfacial tension and surface energy to deliver substances to reactive proximity. Additionally, substances that are not soluble in water may not be vulnerable to reaction based on the limited exposure to reactive conditions.

D7, as illustrated above, is a formula which overcomes physiochemical barriers to deliver reactive oxidation species to pathogenic targets and by virtue of its design, aid in the ability to bring resistant substances into solution where they are then vulnerable to oxidation by the mechanisms embodied in D7. This new version of the formula is an enhancement of previous versions and demonstrates a more robust and effective ability to perform decontamination/disinfection tasks. By alteration of the surfactant characteristics of the formula, we are able to show faster decontamination times and more complete defeat of protective pathogenic layers leading to better remediation results.

D7 is a decontamination agent that delivers chemical oxidation energy in a safe, dilute form for the purpose of promoting oxidation of toxins to less harmful or totally benign breakdown products. D7 chemically treats toxins by promoting oxidation and by consequence speeding up the decontamination process. By itself, D7 will work to promote decontamination. The application of SSDX-12 before D7 enhances the net effect by enabling of the displacement of adsorbed substances.

In one embodiment, the ratio of 30:1 equivalent dosage of D7 with SSDX-12 is desirable to achieve the targeted results with the right properties and effects on surface decontamination.

In one embodiment, the SSDX formulation may include an improved process for decontamination of surfaces using a tiered approach based on D7 formula having pathogen/agent/toxin mobilization followed by pathogen/agent/toxin destruction on the surface, wherein the D7 formula has SSDX-12 added with a ratio of 30:1 equivalent dosage.

### EXAMPLE 5

### SSDX 15:1 and Gen 5 Quat

SSDX-12 is designed to achieve a safe, environmentally benign, low regret physiochemical agency capable of enabling conditions favorable toward the removal or deshielding of pathogens/agents/contaminant/toxins. With the application of SSDX-12, the offending substance can be hydraulically removed or rendered hydraulically vulnerable.

In one example, the SSDX-12 may include a cleaning composition such as a C.sub.8-22 alkyl dimethylamine oxide surfactant, a C.sub.6-12 alkyl dimethylamine oxide surfactant, a C.sub.8-18 alkyl polyethylene glycol sorbitan fatty ester surfactant, and a C.sub.12-14 secondary alcohol ethoxylate surfactant. The C.sub.8-18 alkyl polyethylene glycol sorbitan fatty ester surfactant includes from 0 to about 20 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule.

In yet another embodiment, a cleaning composition for cleaning exterior surfaces of a vehicle is provided. The cleaning composition includes from about 0.1% to about 5% by weight of a C.sub.8-16 alkyl dimethylamine oxide surfactant, from about 0.1% to about 5% by weight of a C.sub.6-10 alkyl dimethylamine oxide surfactant, from about 0.1% to about 5% by weight of a C.sub.10-14 alkyl polyethylene glycol sorbitan fatty ester surfactant, and from about 0.1% to about 5% by weight of a C.sub.12-14 secondary alcohol ethoxylate surfactant including from about 14 to about 16 ethoxylate groups per C.sub.12-14 secondary alcohol ethoxylate surfactant molecule. The C.sub.10-14 alkyl polyethylene glycol sorbitan fatty ester surfactant includes from 0 to about 6 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule. The C.sub.8-16 alkyl dimethylamine oxide surfactant, the C.sub.6-10 alkyl dimethylamine oxide surfactant, the C.sub.10-14 alkyl polyethylene glycol sorbitan fatty ester surfactant, and the C.sub.12-14 secondary alcohol ethoxylate surfactant are provided in a 1:1:1:1 ratio in the cleaning composition. The cleaning composition is effective to remove chemical warfare agents from the exterior surfaces of the vehicle upon application thereto.

In one application, a method for cleaning exterior surfaces of a vehicle using the above cleaning composition may be applied. The method includes providing a cleaning composition, applying the cleaning composition to the exterior surfaces of the vehicle, and rinsing the exterior surfaces of the vehicle with water.

However, once displaced from its microscopic perch, substances may then be exposed to the reactive spectrum (photoelectric radiation, oxidation, chemical modification by an external substance) that facilitates its chemical transformation. In other words, the fact that SSDX-12 was able to be applied as a cleaning composition to a surface of a vehicle, for example, does not mean the dissolved solution is not toxic or environmentally friendly. That is to say, in this state, a toxin becomes highly vulnerable to natural forces which promote its inevitable tumble to its lowest energy state.

A concrete surface may look solid from our perspective but when viewed microscopically, it can consist of a complex network of pathways. This is the same with any porous surface. Close inspection reveals a labyrinth in many cases. Delivering chemistry into this microscopic environment requires that significant surface tension forces be overcome. Surface tension is the property of a liquid that defines how it spreads out on a surface and how well it will penetrate into a surface. The proprietary formulation elements of D7 enable very low surface tension values to be obtained at a surface. These values are not equilibrium values but rather, dynamic values. A turbulent solution, made so by the effervescence of decomposing hydrogen peroxide, will continuously be refreshing itself at the leading edges of its penetration into a surface. These transient ultra-low surface tension values enable a deeper penetration of the active chemistry embodied in D7. The cationic quaternary amine surfactants, coupled with the alkaline pH carbonated buffer system lay the pathway for a more effective penetrating delivery of the complex cleaning chemistry embodied in D7. The product behaves in ways similar to the mechanisms behind hydraulic fracturing without the high pressure pumps.

Alkali carbonates (potassium based) interact with the predominantly negatively biased surface

Quaternary amines adsorb strongly onto that negatively biased surface

Hydraulic channels are opened allowing delivery of the cleaning power in the form of water, peroxide, and other formulation nonionic species.

In its ability to penetrate/eradicate biofilms vs. traditional forms, D7 provides advantages over prior technologies as well. In one example, biofilms are comprised of a secreted chemical matrix that protects pathogen colonies from intruding threats. These films have nutrient causeways, respiration causeways and transpiration causeways and their precise nature is the subject of intense inquiry. The physiochemical solution properties of D7 interact in such a way as to efficiently and thoroughly disrupt those surfaces. The solvency properties and the oxidation from peroxide and peracetic acid species effectively “pry” open the surface of the film and in some cases aid in the defeat of the functional causeways resulting in terminal disruption. Biofilms effectively organize water in a secreted extracellular matrix that in many cases are disrupted by the D7 detergency mechanisms.

Embodiments of D7 describe an enhanced chemical formulation designed for the decontamination, disinfection and renewal of surfaces exposed to chemical, biological and toxic industrial contaminants and residues. This formula improves on prior art by expanding the efficacy spectrum, decreasing treatment time, modifying chemical properties allowing for lower effective dosage and broadening the roster of chemical agents remediated by it. The formulation described herein may also be applied in variable concentrations to achieve decontamination objectives (cleaning, sanitization, disinfection, high level disinfection, mold remediation, biofilm remediation, targeted decontamination).

Embodiments of D7 aim to incremental variants designed to perform particular tasks is the intent of this effort. In one embodiment, aspects of the invention may be formulated with a Generation 1 version of Quaternary amine (ADBAC). It is thought that broadening the type of quaternary amine may bring a benefit in either efficacy against a broader range pathogens or greater effectiveness against biofilms. Of the two, biofilm effectiveness is likely the prominent value proposition.

Furthermore, D7 provides a simple roster of ingredients. D7 is not made of exotic ingredients. It is assembled with common, benign, readily available materials. Their combination produces a net effect greater than the simple sum of each.

The physical properties embodied in D7 tell part of the story of its success.

Things like dynamic surface tension, critical micelle concentration, micellar aggregation number, solvolytic potential and solution polarity all contribute to the enigmatic behavior of D7.

One of the more compelling actions of D7 arises from the micelle formations. These micelles act as miniature reaction factories where toxicants react with activated oxygen species rendering them neutralized or harmless.

As a starting point, the application of D7 in response to biofilm issues seems a valued efficacy for the customer. Defeating a biofilm protected bacteria colony virtually insures defeat of the prokaryotic bacteria itself. The roster of efficacy of D7 in relation to various organisms is listed below:

Disinfection Efficacy

| | | |
|---|---|---|
| Eschericia Coli | Listeria Monocytogenes | Staphylococcus Aureus |
| | | (MRSA, VRSA) |
| Klebsiella pneumoniae | Stereptococcus | Enterobacter cloacae |
| | epidermidis | |

Taking a view of the relationship of the quat generation, the following comparison is relevant.

Generation 5 Quaternary Amine. This category is a mixture of generation 1 and generation 4. The innovation options can rapidly multiply when one considers permutations of different generation 1 chemistries along with the generation 4 variants. In one embodiment, D7 formulation includes:

| Vendor | Product | Description | Notes |
|---|---|---|---|
| Stepan | BTC-1210 | 80% Active | Different foaming characteristics, |
| | | 32% CAS 68424-85-1 | different efficacy profile, different |
| Pilot | Maquat | 48% CAS 7173-51-5 | physiochemical performance, |
| | 2420-80% | | enhanced biofilm defeat efficacy, |
| | | | residual sanitation performance |
| Stepan | BTC-888 | 80% Active | Different foaming characteristics, |
| | | 32% CAS 68424-85-1 | different efficacy profile, different |
| Pilot | MQ-624M | 48% Variable dialkyl, dimethyl | physiochemical performance |

| Part A Formulation Ingredient | Prescribed amount |
|---|---|
| BTC 888 (80% active) 32% (40% C12, 50% C14, 10% C16) + 48% | 0.1 to 4.00% |
| DADMAC | |
| Octyl Decyl Dimethyl Ammonium Chloride (24%) MW = 334.0273 | 0.024 to 0.960% |
| Di-n-Octyl Ammonium Chloride (12%) MW = 270.5207 | 0.012 to 0.480% |
| Di-n-Decyl Ammonium Chloride (12%) MW = 326.6279 | 0.012 to 0.480% |
| ADBAC C12 (40%) MW = 339.9909 | 0.0128 to 0.512% |
| ADBAC C14 (50%) MW = 368.0445 | 0.016 to 0.640% |
| ADBAC C16 (10%) MW = 396.0981 | 0.0032 to 0.128% |
| Adogen 477D (50% Active) | 0.05 to 2.00% |
| Glycol Ether DB | 0.4 to 1.60% |
| Isobutanol | 0.025 to 1.00% |
| Propylene Glycol | 0.5 to 20.00% |
| Lauryl Alcohol | 0.02 to 0.80% |
| Potassium Bicarb USP Anhyd | 0.3 to 12.00% |
| Caustic Potash | 0.0425 to 1.70% |
| Water | 56.90 to 98.56% |
| Part B Formulation Ingredient | Prescribed amount |
| Hydrogen peroxide | 0.2 to 8.00% |
| Inerts and stabilizers | |
| Water | 99.8 to 85% |
| Part C Formulation Ingredient | Prescribed amount |
| Bleaching accelerator | 0.05 to 2.00% |

In one embodiment, the Generation 5 surfactants and dimethyl dialkyl quaternary amines present an enhanced structure to the micelles developed in the D7 formulation.

These surfactants may modify the Gouy-Chapman-Stern layer to the point of enhanced and improved ability to more rapidly solubilize agents into the micelle body.

In one example, the surfactants may modify the Gouy-Chapman-Stern layer that may be tied to the speed at which an agent is decontaminated, or it might be the extent of its decontamination.

This embodiment of the invention may have different physical properties. The efficacy profile of this version will also be different. The development of the efficacy profile should be from a dilute version, perhaps a 1 to 100 dilution of the final product, up to the full version. The dilute version might be considered for surfaces that are already clean and devoid of biofilm presence. In one embodiment, the concentrated version would be considered for circumstances where gross filth is more prevalent (live animal facilities, processing plants, high biofilm potential places). Various embodiments of the invention for different dilutions (bacteria, biofilm, fogging efficacy) may enable various levels of applications in addition to those disclosed in FIG. 1.

This improvement upon prior art enables the contemplation of a full spectrum product capable of dealing with sensitive cleaning and sanitization situations like those encountered in food contact circumstances. In those circumstances, a product may be able to be applied to a target surface usually as a spray and wiped down distributing the cleaning/sanitization formulation over the entire surface. In one embodiment, aspects of the invention may need to receive approval from regulatory oversight agencies before use. In this case, this is commonly known as a “leave-on” product. There are statutory limits of labeled ingredients permissible for this type of use. It is an embodied intention of this improvement to enable this type of use. A full strength version of the product is intended for use in highly compromised environments like live animal barns where significant gross filth is anticipated. This represents the other end of the product spectrum. Regulatory oversight is also a requisite in relation to pesticidal embodiments. It is anticipated that there will be many situations in between these two extremes where a strength modulated product would serve the need. Examples of such situations are given in spectrum above.

It is often necessary to promote a speedier transition to a less harmful state. Pathogens, toxic industrial chemicals, or other undesirable substances exist unchallenged in ambient environments except by those reactive agents common to their surroundings. The natural remedies for treatment of infestations include predation by organisms, hydrolysis by water, photolysis by electromagnetic radiation, absorption by the substrate and shielding of the pathogen by environmental film to name a few. If a pathogen is soluble in water, a simple rinse may suffice. The kinetic time frame for these actions can range from the immediate to very long periods of slow transition. Delivering reactive chemical activity in the form of oxidation or nucleophillic substitution is an effective treatment strategy well known in common practice. It is the route by which numerous agents deliver their efficacious dose. Once a substance is oxidized, it is generally more susceptible to environmental decay via one or more of the aforementioned mechanisms. Delivering oxidation activity to a target is not always straight forward. The use of bleach for instance is a common practice in many areas for disinfection and decontamination. Bleach is a water based solution whose ability to penetrate and engage pathogens is limited to the physiochemical barriers embodied on the substrate being treated. If the active cidal agent cannot come into reactive proximity with the target pathogen, nothing will happen. For this reason, disinfection and decontamination agents are formulated with substances that enable the ability overcome physiochemical barriers of interfacial tension and surface energy to deliver substances to reactive proximity. Additionally, substances that are not soluble in water may not be vulnerable to reaction based on the limited exposure to reactive conditions.

D7, as illustrated above, is a formula which overcomes physiochemical barriers to deliver reactive oxidation species to pathogenic targets and by virtue of its design, aid in the ability to bring resistant substances into solution where they are then vulnerable to oxidation by the mechanisms embodied in D7. This new version of the formula is an enhancement of previous versions and demonstrates a more robust and effective ability to perform decontamination/disinfection tasks. By alteration of the surfactant characteristics of the formula, we are able to show faster decontamination times and more complete defeat of protective pathogenic layers leading to better remediation results.

D7 is a decontamination agent that delivers chemical oxidation energy in a safe, dilute form for the purpose of promoting oxidation of toxins to less harmful or totally benign breakdown products. D7 chemically treats toxins by promoting oxidation and by consequence speeding up the decontamination process. By itself, D7 will work to promote decontamination. The application of SSDX-12 before D7 enhances the net effect by enabling of the displacement of adsorbed substances.

In one embodiment, the ratio of 15:1 equivalent dosage of D7 with SSDX-12 is desirable to achieve the targeted results with the right properties and effects on surface decontamination.

In another embodiment, in improving foaming characteristics of the combination of D7 and SSDX-12, BTC 8358 may be used instead of BTC 888 for Generation 5 Quaternary. In one example, such modified Generation 5 Quaternary at about 4.0% may have desirable result in reducing foaming when the combination of D7 (with 15:1 equivalent dosage of SSDX-12 added) is applied to a given surface to treat the contaminants.

In one embodiment, the SSDX formulation may include an improved process for decontamination of surfaces using a tiered approach based on D7 formula having pathogen/agent/toxin mobilization followed by pathogen/agent/toxin destruction on the surface, wherein the D7 formula has SSDX-12 added with a ratio of 15:1 equivalent dosage, wherein BTC 8358 replaces BTC 888 at about 4.0% for Generation 5 Quaternary of D7.

### EXAMPLE 6

### SSDX 30:1 and Gen 5 Quat

SSDX-12 is designed to achieve a safe, environmentally benign, low regret physiochemical agency capable of enabling conditions favorable toward the removal or deshielding of pathogens/agents/contaminant/toxins. With the application of SSDX-12, the offending substance can be hydraulically removed or rendered hydraulically vulnerable.

In one example, the SSDX-12 may include a cleaning composition such as a C.sub.8-22 alkyl dimethylamine oxide surfactant, a C.sub.6-12 alkyl dimethylamine oxide surfactant, a C.sub.8-18 alkyl polyethylene glycol sorbitan fatty ester surfactant, and a C.sub.12-14 secondary alcohol ethoxylate surfactant. The C.sub.8-18 alkyl polyethylene glycol sorbitan fatty ester surfactant includes from 0 to about 20 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule.

In yet another embodiment, a cleaning composition for cleaning exterior surfaces of a vehicle is provided. The cleaning composition includes from about 0.1% to about 5% by weight of a C.sub.8-16 alkyl dimethylamine oxide surfactant, from about 0.1% to about 5% by weight of a C.sub.6-10 alkyl dimethylamine oxide surfactant, from about 0.1% to about 5% by weight of a C.sub.10-14 alkyl polyethylene glycol sorbitan fatty ester surfactant, and from about 0.1% to about 5% by weight of a C.sub.12-14 secondary alcohol ethoxylate surfactant including from about 14 to about 16 ethoxylate groups per C.sub.12-14 secondary alcohol ethoxylate surfactant molecule. The C.sub.10-14 alkyl polyethylene glycol sorbitan fatty ester surfactant includes from 0 to about 6 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule. The C.sub.8-16 alkyl dimethylamine oxide surfactant, the C.sub.6-10 alkyl dimethylamine oxide surfactant, the C.sub.10-14 alkyl polyethylene glycol sorbitan fatty ester surfactant, and the C.sub.12-14 secondary alcohol ethoxylate surfactant are provided in a 1:1:1:1 ratio in the cleaning composition. The cleaning composition is effective to remove chemical warfare agents from the exterior surfaces of the vehicle upon application thereto.

In one application, a method for cleaning exterior surfaces of a vehicle using the above cleaning composition may be applied. The method includes providing a cleaning composition, applying the cleaning composition to the exterior surfaces of the vehicle, and rinsing the exterior surfaces of the vehicle with water.

However, once displaced from its microscopic perch, substances may then be exposed to the reactive spectrum (photoelectric radiation, oxidation, chemical modification by an external substance) that facilitates its chemical transformation. In other words, the fact that SSDX-12 was able to be applied as a cleaning composition to a surface of a vehicle, for example, does not mean the dissolved solution is not toxic or environmentally friendly. That is to say, in this state, a toxin becomes highly vulnerable to natural forces which promote its inevitable tumble to its lowest energy state.

A concrete surface may look solid from our perspective but when viewed microscopically, it can consist of a complex network of pathways. This is the same with any porous surface. Close inspection reveals a labyrinth in many cases. Delivering chemistry into this microscopic environment requires that significant surface tension forces be overcome. Surface tension is the property of a liquid that defines how it spreads out on a surface and how well it will penetrate into a surface. The proprietary formulation elements of D7 enable very low surface tension values to be obtained at a surface. These values are not equilibrium values but rather, dynamic values. A turbulent solution, made so by the effervescence of decomposing hydrogen peroxide, will continuously be refreshing itself at the leading edges of its penetration into a surface. These transient ultra-low surface tension values enable a deeper penetration of the active chemistry embodied in D7. The cationic quaternary amine surfactants, coupled with the alkaline pH carbonated buffer system lay the pathway for a more effective penetrating delivery of the complex cleaning chemistry embodied in D7. The product behaves in ways similar to the mechanisms behind hydraulic fracturing without the high pressure pumps.

Alkali carbonates (potassium based) interact with the predominantly negatively biased surface

Quaternary amines adsorb strongly onto that negatively biased surface

Hydraulic channels are opened allowing delivery of the cleaning power in the form of water, peroxide, and other formulation nonionic species.

In its ability to penetrate/eradicate biofilms vs. traditional forms, D7 provides advantages over prior technologies as well. In one example, biofilms are comprised of a secreted chemical matrix that protects pathogen colonies from intruding threats. These films have nutrient causeways, respiration causeways and transpiration causeways and their precise nature is the subject of intense inquiry. The physiochemical solution properties of D7 interact in such a way as to efficiently and thoroughly disrupt those surfaces. The solvency properties and the oxidation from peroxide and peracetic acid species effectively “pry” open the surface of the film and in some cases aid in the defeat of the functional causeways resulting in terminal disruption. Biofilms effectively organize water in a secreted extracellular matrix that in many cases are disrupted by the D7 detergency mechanisms.

Embodiments of D7 describe an enhanced chemical formulation designed for the decontamination, disinfection and renewal of surfaces exposed to chemical, biological and toxic industrial contaminants and residues. This formula improves on prior art by expanding the efficacy spectrum, decreasing treatment time, modifying chemical properties allowing for lower effective dosage and broadening the roster of chemical agents remediated by it. The formulation described herein may also be applied in variable concentrations to achieve decontamination objectives (cleaning, sanitization, disinfection, high level disinfection, mold remediation, biofilm remediation, targeted decontamination).

Embodiments of D7 aim to incremental variants designed to perform particular tasks is the intent of this effort. In one embodiment, aspects of the invention may be formulated with a Generation 1 version of Quaternary amine (ADBAC). It is thought that broadening the type of quaternary amine may bring a benefit in either efficacy against a broader range pathogens or greater effectiveness against biofilms. Of the two, biofilm effectiveness is likely the prominent value proposition.

Furthermore, D7 provides a simple roster of ingredients. D7 is not made of exotic ingredients. It is assembled with common, benign, readily available materials. Their combination produces a net effect greater than the simple sum of each.

The physical properties embodied in D7 tell part of the story of its success. Things like dynamic surface tension, critical micelle concentration, micellar aggregation number, solvolytic potential and solution polarity all contribute to the enigmatic behavior of D7.

One of the more compelling actions of D7 arises from the micelle formations. These micelles act as miniature reaction factories where toxicants react with activated oxygen species rendering them neutralized or harmless.

As a starting point, the application of D7 in response to biofilm issues seems a valued efficacy for the customer. Defeating a biofilm protected bacteria colony virtually insures defeat of the prokaryotic bacteria itself. The roster of efficacy of D7 in relation to various organisms is listed below:

Disinfection Efficacy

| | | |
|---|---|---|
| Eschericia Coli | Listeria Monocytogenes | Staphylococcus Aureus |
| | | (MRSA, VRSA) |
| Klebsiella pneumoniae | Stereptococcus | Enterobacter cloacae |
| | epidermidis | |

Taking a view of the relationship of the quat generation, the following comparison is relevant.

Generation 5 Quaternary Amine. This category is a mixture of generation 1 and generation 4. The innovation options can rapidly multiply when one considers permutations of different generation 1 chemistries along with the generation 4 variants. In one embodiment, D7 formulation includes:

| Vendor | Product | Description | Notes |
|---|---|---|---|
| Stepan | BTC-1210 | 80% Active | Different foaming characteristics, |
| | | 32% CAS 68424-85-1 | different efficacy profile, different |
| Pilot | Maquat | 48% CAS 7173-51-5 | physiochemical performance, |
| | 2420-80% | | enhanced biofilm defeat efficacy, |
| | | | residual sanitation performance |
| Stepan | BTC-888 | 80% Active | Different foaming characteristics, |
| | | 32% CAS 68424-85-1 | different efficacy profile, different |
| Pilot | MQ-624M | 48% Variable dialkyl, dimethyl | physiochemical performance |

| Part A Formulation Ingredient | Prescribed amount |
|---|---|
| BTC 888 (80% active) 32% (40% C12, 50% C14, 10% C16) + 48% | 0.1 to 4.00% |
| DADMAC | |
| Octyl Decyl Dimethyl Ammonium Chloride (24%) MW = 334.0273 | 0.024 to 0.960% |
| Di-n-Octyl Ammonium Chloride (12%) MW = 270.5207 | 0.012 to 0.480% |
| Di-n-Decyl Ammonium Chloride (12%) MW = 326.6279 | 0.012 to 0.480% |
| ADBAC C12 (40%) MW = 339.9909 | 0.0128 to 0.512% |
| ADBAC C14 (50%) MW = 368.0445 | 0.016 to 0.640% |
| ADBAC C16 (10%) MW = 396.0981 | 0.0032 to 0.128% |
| Adogen 477D (50% Active) | 0.05 to 2.00% |
| Glycol Ether DB | 0.4 to 1.60% |
| Isobutanol | 0.025 to 1.00% |
| Propylene Glycol | 0.5 to 20.00% |
| Lauryl Alcohol | 0.02 to 0.80% |
| Potassium Bicarb USP Anhyd | 0.3 to 12.00% |
| Caustic Potash | 0.0425 to 1.70% |
| Water | 56.90 to 98.56% |
| Part B Formulation Ingredient | Prescribed amount |
| Hydrogen peroxide | 0.2 to 8.00% |
| Inerts and stabilizers | |
| Water | 99.8 to 85% |
| Part C Formulation Ingredient | Prescribed amount |
| Bleaching accelerator | 0.05 to 2.00% |

In one embodiment, the Generation 5 surfactants and dimethyl dialkyl quaternary amines present an enhanced structure to the micelles developed in the D7 formulation.

These surfactants may modify the Gouy-Chapman-Stern layer to the point of enhanced and improved ability to more rapidly solubilize agents into the micelle body.

In one example, the surfactants may modify the Gouy-Chapman-Stern layer that may be tied to the speed at which an agent is decontaminated, or it might be the extent of its decontamination.

This embodiment of the invention may have different physical properties. The efficacy profile of this version will also be different. The development of the efficacy profile should be from a dilute version, perhaps a 1 to 100 dilution of the final product, up to the full version. The dilute version might be considered for surfaces that are already clean and devoid of biofilm presence. In one embodiment, the concentrated version would be considered for circumstances where gross filth is more prevalent (live animal facilities, processing plants, high biofilm potential places). Various embodiments of the invention for different dilutions (bacteria, biofilm, fogging efficacy) may enable various levels of applications in addition to those disclosed in FIG. 1.

This improvement upon prior art enables the contemplation of a full spectrum product capable of dealing with sensitive cleaning and sanitization situations like those encountered in food contact circumstances. In those circumstances, a product may be able to be applied to a target surface usually as a spray and wiped down distributing the cleaning/sanitization formulation over the entire surface. In one embodiment, aspects of the invention may need to receive approval from regulatory oversight agencies before use. In this case, this is commonly known as a “leave-on” product. There are statutory limits of labeled ingredients permissible for this type of use. It is an embodied intention of this improvement to enable this type of use. A full strength version of the product is intended for use in highly compromised environments like live animal barns where significant gross filth is anticipated. This represents the other end of the product spectrum. Regulatory oversight is also a requisite in relation to pesticidal embodiments. It is anticipated that there will be many situations in between these two extremes where a strength modulated product would serve the need. Examples of such situations are given in spectrum above.

It is often necessary to promote a speedier transition to a less harmful state. Pathogens, toxic industrial chemicals, or other undesirable substances exist unchallenged in ambient environments except by those reactive agents common to their surroundings. The natural remedies for treatment of infestations include predation by organisms, hydrolysis by water, photolysis by electromagnetic radiation, absorption by the substrate and shielding of the pathogen by environmental film to name a few. If a pathogen is soluble in water, a simple rinse may suffice. The kinetic time frame for these actions can range from the immediate to very long periods of slow transition. Delivering reactive chemical activity in the form of oxidation or nucleophillic substitution is an effective treatment strategy well known in common practice. It is the route by which numerous agents deliver their efficacious dose. Once a substance is oxidized, it is generally more susceptible to environmental decay via one or more of the aforementioned mechanisms. Delivering oxidation activity to a target is not always straight forward. The use of bleach for instance is a common practice in many areas for disinfection and decontamination. Bleach is a water based solution whose ability to penetrate and engage pathogens is limited to the physiochemical barriers embodied on the substrate being treated. If the active cidal agent cannot come into reactive proximity with the target pathogen, nothing will happen. For this reason, disinfection and decontamination agents are formulated with substances that enable the ability overcome physiochemical barriers of interfacial tension and surface energy to deliver substances to reactive proximity. Additionally, substances that are not soluble in water may not be vulnerable to reaction based on the limited exposure to reactive conditions.

D7, as illustrated above, is a formula which overcomes physiochemical barriers to deliver reactive oxidation species to pathogenic targets and by virtue of its design, aid in the ability to bring resistant substances into solution where they are then vulnerable to oxidation by the mechanisms embodied in D7. This new version of the formula is an enhancement of previous versions and demonstrates a more robust and effective ability to perform decontamination/disinfection tasks. By alteration of the surfactant characteristics of the formula, we are able to show faster decontamination times and more complete defeat of protective pathogenic layers leading to better remediation results.

D7 is a decontamination agent that delivers chemical oxidation energy in a safe, dilute form for the purpose of promoting oxidation of toxins to less harmful or totally benign breakdown products. D7 chemically treats toxins by promoting oxidation and by consequence speeding up the decontamination process. By itself, D7 will work to promote decontamination. The application of SSDX-12 before D7 enhances the net effect by enabling of the displacement of adsorbed substances.

In one embodiment, the ratio of 30:1 equivalent dosage of D7 with SSDX-12 is desirable to achieve the targeted results with the right properties and effects on surface decontamination.

In another embodiment, in improving foaming characteristics of the combination of D7 and SSDX-12, BTC 8358 may be used instead of BTC 888 for Generation 5 Quaternary. In one example, such modified Generation 5 Quaternary at about 4.0% may have desirable result in reducing foaming when the combination of D7 (with 30:1 equivalent dosage of SSDX-12 added) is applied to a given surface to treat the contaminants.

### EXAMPLE 7

### Laundry Application

SSDX-12 is designed to achieve a safe, environmentally benign, low regret physiochemical agency capable of enabling conditions favorable toward the removal or deshielding of pathogens/agents/contaminant/toxins. With the application of SSDX-12, the offending substance can be hydraulically removed or rendered hydraulically vulnerable.

In one example, the SSDX-12 may include a cleaning composition such as a C.sub.8-22 alkyl dimethylamine oxide surfactant, a C.sub.6-12 alkyl dimethylamine oxide surfactant, a C.sub.8-18 alkyl polyethylene glycol sorbitan fatty ester surfactant, and a C.sub.12-14 secondary alcohol ethoxylate surfactant. The C.sub.8-18 alkyl polyethylene glycol sorbitan fatty ester surfactant includes from 0 to about 20 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule.

In yet another embodiment, a cleaning composition for cleaning exterior surfaces of a vehicle is provided. The cleaning composition includes from about 0.1% to about 5% by weight of a C.sub.8-16 alkyl dimethylamine oxide surfactant, from about 0.1% to about 5% by weight of a C.sub.6-10 alkyl dimethylamine oxide surfactant, from about 0.1% to about 5% by weight of a C.sub.10-14 alkyl polyethylene glycol sorbitan fatty ester surfactant, and from about 0.1% to about 5% by weight of a C.sub.12-14 secondary alcohol ethoxylate surfactant including from about 14 to about 16 ethoxylate groups per C.sub.12-14 secondary alcohol ethoxylate surfactant molecule. The C.sub.10-14 alkyl polyethylene glycol sorbitan fatty ester surfactant includes from 0 to about 6 ethoxylate groups per C.sub.8-18 alkyl polyethylene glycol sorbitan fatty ester surfactant molecule. The C.sub.12-14 secondary alcohol ethoxylate surfactant includes from about 14 to about 16 ethoxylate groups per C.sub.12-14 secondary alcohol ethoxylate surfactant molecule. The C.sub.8-16 alkyl dimethylamine oxide surfactant, the C.sub.6-10 alkyl dimethylamine oxide surfactant, the C.sub.10-14 alkyl polyethylene glycol sorbitan fatty ester surfactant, and the C.sub.12-14 secondary alcohol ethoxylate surfactant are provided in a 1:1:1:1 ratio in the cleaning composition. The cleaning composition is effective to remove chemical warfare agents from the exterior surfaces of the vehicle upon application thereto.

In one application, a method for cleaning exterior surfaces of a vehicle using the above cleaning composition may be applied. The method includes providing a cleaning composition, applying the cleaning composition to the exterior surfaces of the vehicle, and rinsing the exterior surfaces of the vehicle with water.

However, once displaced from its microscopic perch, substances may then be exposed to the reactive spectrum (photoelectric radiation, oxidation, chemical modification by an external substance) that facilitates its chemical transformation. In other words, the fact that SSDX-12 was able to be applied as a cleaning composition to a surface of a vehicle, for example, does not mean the dissolved solution is not toxic or environmentally friendly. That is to say, in this state, a toxin becomes highly vulnerable to natural forces which promote its inevitable tumble to its lowest energy state.

A concrete surface may look solid from our perspective but when viewed microscopically, it can consist of a complex network of pathways. This is the same with any porous surface. Close inspection reveals a labyrinth in many cases. Delivering chemistry into this microscopic environment requires that significant surface tension forces be overcome. Surface tension is the property of a liquid that defines how it spreads out on a surface and how well it will penetrate into a surface. The proprietary formulation elements of D7 enable very low surface tension values to be obtained at a surface. These values are not equilibrium values but rather, dynamic values. A turbulent solution, made so by the effervescence of decomposing hydrogen peroxide, will continuously be refreshing itself at the leading edges of its penetration into a surface. These transient ultra-low surface tension values enable a deeper penetration of the active chemistry embodied in D7. The cationic quaternary amine surfactants, coupled with the alkaline pH carbonated buffer system lay the pathway for a more effective penetrating delivery of the complex cleaning chemistry embodied in D7. The product behaves in ways similar to the mechanisms behind hydraulic fracturing without the high pressure pumps.

Alkali carbonates (potassium based) interact with the predominantly negatively biased surface

Quaternary amines adsorb strongly onto that negatively biased surface

Hydraulic channels are opened allowing delivery of the cleaning power in the form of water, peroxide, and other formulation nonionic species.

In its ability to penetrate/eradicate biofilms vs. traditional forms, D7 provides advantages over prior technologies as well. In one example, biofilms are comprised of a secreted chemical matrix that protects pathogen colonies from intruding threats. These films have nutrient causeways, respiration causeways and transpiration causeways and their precise nature is the subject of intense inquiry. The physiochemical solution properties of D7 interact in such a way as to efficiently and thoroughly disrupt those surfaces. The solvency properties and the oxidation from peroxide and peracetic acid species effectively “pry” open the surface of the film and in some cases aid in the defeat of the functional causeways resulting in terminal disruption. Biofilms effectively organize water in a secreted extracellular matrix that in many cases are disrupted by the D7 detergency mechanisms.

Embodiments of D7 describe an enhanced chemical formulation designed for the decontamination, disinfection and renewal of surfaces exposed to chemical, biological and toxic industrial contaminants and residues. This formula improves on prior art by expanding the efficacy spectrum, decreasing treatment time, modifying chemical properties allowing for lower effective dosage and broadening the roster of chemical agents remediated by it. The formulation described herein may also be applied in variable concentrations to achieve decontamination objectives (cleaning, sanitization, disinfection, high level disinfection, mold remediation, biofilm remediation, targeted decontamination).

Embodiments of D7 aim to incremental variants designed to perform particular tasks is the intent of this effort. In one embodiment, aspects of the invention may be formulated with a Generation 1 version of Quaternary amine (ADBAC). It is thought that broadening the type of quaternary amine may bring a benefit in either efficacy against a broader range pathogens or greater effectiveness against biofilms. Of the two, biofilm effectiveness is likely the prominent value proposition.

Furthermore, D7 provides a simple roster of ingredients. D7 is not made of exotic ingredients. It is assembled with common, benign, readily available materials. Their combination produces a net effect greater than the simple sum of each.

The physical properties embodied in D7 tell part of the story of its success. Things like dynamic surface tension, critical micelle concentration, micellar aggregation number, solvolytic potential and solution polarity all contribute to the enigmatic behavior of D7.

One of the more compelling actions of D7 arises from the micelle formations. These micelles act as miniature reaction factories where toxicants react with activated oxygen species rendering them neutralized or harmless.

As a starting point, the application of D7 in response to biofilm issues seems a valued efficacy for the customer. Defeating a biofilm protected bacteria colony virtually insures defeat of the prokaryotic bacteria itself. The roster of efficacy of D7 in relation to various organisms is listed below:

Disinfection Efficacy

| | | |
|---|---|---|
| Eschericia Coli | Listeria Monocytogenes | Staphylococcus Aureus |
| | | (MRSA, VRSA) |
| Klebsiella pneumoniae | Stereptococcus | Enterobacter cloacae |
| | epidermidis | |

Taking a view of the relationship of the quat generation, the following comparison is relevant.

Generation 5 Quaternary Amine. This category is a mixture of generation 1 and generation 4. The innovation options can rapidly multiply when one considers permutations of different generation 1 chemistries along with the generation 4 variants. In one embodiment, D7 formulation includes:

| Vendor | Product | Description | Notes |
|---|---|---|---|
| Stepan | BTC-1210 | 80% Active | Different foaming characteristics, |
| | | 32% CAS 68424-85-1 | different efficacy profile, different |
| Pilot | Maquat | 48% CAS 7173-51-5 | physiochemical performance, |
| | 2420-80% | | enhanced biofilm defeat efficacy, |
| | | | residual sanitation performance |
| Stepan | BTC-888 | 80% Active | Different foaming characteristics, |
| | | 32% CAS 68424-85-1 | different efficacy profile, different |
| Pilot | MQ-624M | 48% Variable dialkyl, dimethyl | physiochemical performance |

| Part A Formulation Ingredient | Prescribed amount |
|---|---|
| BTC 888 (80% active) 32% (40% C12, 50% C14, 10% C16) + 48% | 0.1 to 4.00% |
| DADMAC | |
| Octyl Decyl Dimethyl Ammonium Chloride (24%) MW = 334.0273 | 0.024 to 0.960% |
| Di-n-Octyl Ammonium Chloride (12%) MW = 270.5207 | 0.012 to 0.480% |
| Di-n-Decyl Ammonium Chloride (12%) MW = 326.6279 | 0.012 to 0.480% |
| ADBAC C12 (40%) MW = 339.9909 | 0.0128 to 0.512% |
| ADBAC C14 (50%) MW = 368.0445 | 0.016 to 0.640% |
| ADBAC C16 (10%) MW = 396.0981 | 0.0032 to 0.128% |
| Adogen 477D (50% Active) | 0.05 to 2.00% |
| Glycol Ether DB | 0.4 to 1.60% |
| Isobutanol | 0.025 to 1.00% |
| Propylene Glycol | 0.5 to 20.00% |
| Lauryl Alcohol | 0.02 to 0.80% |
| Potassium Bicarb USP Anhyd | 0.3 to 12.00% |
| Caustic Potash | 0.0425 to 1.70% |
| Water | 56.90 to 98.56% |
| Part B Formulation Ingredient | Prescribed amount |
| Hydrogen peroxide | 0.2 to 8.00% |
| Inerts and stabilizers | |
| Water | 99.8 to 85% |
| Part C Formulation Ingredient | Prescribed amount |
| Bleaching accelerator | 0.05 to 2.00% |

In one embodiment, the Generation 5 surfactants and dimethyl dialkyl quaternary amines present an enhanced structure to the micelles developed in the D7 formulation.

These surfactants may modify the Gouy-Chapman-Stern layer to the point of enhanced and improved ability to more rapidly solubilize agents into the micelle body.

In one example, the surfactants may modify the Gouy-Chapman-Stern layer that may be tied to the speed at which an agent is decontaminated, or it might be the extent of its decontamination.

This embodiment of the invention may have different physical properties. The efficacy profile of this version will also be different. The development of the efficacy profile should be from a dilute version, perhaps a 1 to 100 dilution of the final product, up to the full version. The dilute version might be considered for surfaces that are already clean and devoid of biofilm presence. In one embodiment, the concentrated version would be considered for circumstances where gross filth is more prevalent (live animal facilities, processing plants, high biofilm potential places). Various embodiments of the invention for different dilutions (bacteria, biofilm, fogging efficacy) may enable various levels of applications in addition to those disclosed in FIG. 1.

This improvement upon prior art enables the contemplation of a full spectrum product capable of dealing with sensitive cleaning and sanitization situations like those encountered in food contact circumstances. In those circumstances, a product may be able to be applied to a target surface usually as a spray and wiped down distributing the cleaning/sanitization formulation over the entire surface. In one embodiment, aspects of the invention may need to receive approval from regulatory oversight agencies before use. In this case, this is commonly known as a “leave-on” product. There are statutory limits of labeled ingredients permissible for this type of use. It is an embodied intention of this improvement to enable this type of use. A full strength version of the product is intended for use in highly compromised environments like live animal barns where significant gross filth is anticipated. This represents the other end of the product spectrum. Regulatory oversight is also a requisite in relation to pesticidal embodiments. It is anticipated that there will be many situations in between these two extremes where a strength modulated product would serve the need. Examples of such situations are given in spectrum above.

It is often necessary to promote a speedier transition to a less harmful state. Pathogens, toxic industrial chemicals, or other undesirable substances exist unchallenged in ambient environments except by those reactive agents common to their surroundings. The natural remedies for treatment of infestations include predation by organisms, hydrolysis by water, photolysis by electromagnetic radiation, absorption by the substrate and shielding of the pathogen by environmental film to name a few. If a pathogen is soluble in water, a simple rinse may suffice. The kinetic time frame for these actions can range from the immediate to very long periods of slow transition. Delivering reactive chemical activity in the form of oxidation or nucleophillic substitution is an effective treatment strategy well known in common practice. It is the route by which numerous agents deliver their efficacious dose. Once a substance is oxidized, it is generally more susceptible to environmental decay via one or more of the aforementioned mechanisms. Delivering oxidation activity to a target is not always straight forward. The use of bleach for instance is a common practice in many areas for disinfection and decontamination. Bleach is a water based solution whose ability to penetrate and engage pathogens is limited to the physiochemical barriers embodied on the substrate being treated. If the active cidal agent cannot come into reactive proximity with the target pathogen, nothing will happen. For this reason, disinfection and decontamination agents are formulated with substances that enable the ability overcome physiochemical barriers of interfacial tension and surface energy to deliver substances to reactive proximity. Additionally, substances that are not soluble in water may not be vulnerable to reaction based on the limited exposure to reactive conditions.

D7, as illustrated above, is a formula which overcomes physiochemical barriers to deliver reactive oxidation species to pathogenic targets and by virtue of its design, aid in the ability to bring resistant substances into solution where they are then vulnerable to oxidation by the mechanisms embodied in D7. This new version of the formula is an enhancement of previous versions and demonstrates a more robust and effective ability to perform decontamination/disinfection tasks. By alteration of the surfactant characteristics of the formula, we are able to show faster decontamination times and more complete defeat of protective pathogenic layers leading to better remediation results.

D7 is a decontamination agent that delivers chemical oxidation energy in a safe, dilute form for the purpose of promoting oxidation of toxins to less harmful or totally benign breakdown products. D7 chemically treats toxins by promoting oxidation and by consequence speeding up the decontamination process. By itself, D7 will work to promote decontamination. The application of SSDX-12 before D7 enhances the net effect by enabling of the displacement of adsorbed substances.

In one embodiment, the ratio of 15:1 equivalent dosage of D7 with SSDX-12 is desirable to achieve the targeted results with the right properties and effects on surface decontamination.

In another embodiment, in improving foaming characteristics of the combination of D7 and SSDX-12, BTC 8358 may be used instead of BTC 888 for Generation 5 Quaternary. In one example, such modified Generation 5 Quaternary at about 4.0% may have desirable result in reducing foaming when the combination of D7 (with 15:1 or 30:1 equivalent dosage of SSDX-12 added) is applied to a given surface to treat the contaminants.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

Having now fully described the subject compositions and methods, it will be understood by those of ordinary skill in the art that the same can be performed within a wide and equivalent range of conditions, formulations and other parameters without affecting their scope or any embodiment thereof. All cited patents, patent applications and publications are fully incorporated by reference in their entirety.

What is claimed is:

1. A decontamination formulation comprising a mixture of:
a buffer detergent chemical system comprising:
generation 5 Quat;
hydrotrope;
a surfactant system;
a pH buffering system; and
water (balance); and
a hydrogen peroxide chemical comprising:
hydrogen peroxide of about great than 10% and less than 20% of the formulation;
stabilizer of about 0% to 2% of the formulation;
getting agent of about 0% to 2% of the formulation; and
water (balance of the formulation in volume), wherein the buffer detergent chemical system, the hydrogen peroxide chemical and the water mix to form the mixture in a mixing manifold having a mixing chamber in fluid communication with a nozzle.

2. A process for decontaminating surfaces comprising:
applying a first formula having a pathogen, an agent or a toxin mobilization followed by the pathogen, the agent or the toxin destruction on a surface, wherein the first formula includes SSDX-12 added thereto, wherein BTC 8358 chemical replaces BTC 888 at about 4.0% for a generation 5 Quat of the first formula, wherein the first formula comprises:
a mixture of:
a buffer detergent chemical system comprising:
generation 5 Quat;
hydrotrope;
a surfactant system;
a pH buffering system; and
water (balance); and
a hydrogen peroxide chemical comprising:
hydrogen peroxide of about great than 0% to less than 20% of the formulation;
stabilizer of about 0% to 2% of the formulation;
getting agent of about 0% to 2% of the formulation; and
water (balance of the formulation in volume), wherein the buffer detergent chemical system, the hydrogen peroxide chemical and the water mix to form the mixture in a mixing manifold having a mixing chamber in fluid communication with a nozzle.

3. The process of claim 2, wherein the SSDX-12 comprises a ratio of 15:1 equivalent dosage to the first formula.

4. The process of claim 2, wherein the SSDX-12 comprises a ratio of 30:1 equivalent dosage to the first formula.

5. A process for decontaminating surfaces comprising:
applying a first formula having a pathogen, an agent or a toxin mobilization followed by the pathogen, the agent or the toxin destruction on a surface, wherein the first formula includes SSDX-12 added thereto, wherein BTC 8358 chemical replaces BTC 888 at about 4.0% for a generation 5 Quat of the first formula, wherein the first formula comprises:
a mixture of:
a buffer detergent chemical system comprising:
generation 5 Quat;
hydrotrope;
a surfactant system;
a pH buffering system; and
water (balance); and
a hydrogen peroxide chemical comprising:
hydrogen peroxide of about great than 10% and less than 20% of the formulation;
stabilizer of about 0% to 2% of the formulation;
getting agent of about 0% to 2% of the formulation; and
water (balance of the formulation in volume), wherein the buffer detergent chemical system, the hydrogen peroxide chemical and the water mix to form the mixture in a mixing manifold having a mixing chamber in fluid communication with a nozzle.

6. The process of claim 5, wherein the SSDX-12 comprises a ratio of 15:1 equivalent dosage to the first formula.

7. The process of claim 5, wherein the SSDX-12 comprises a ratio of 30:1 equivalent dosage to the first formula.
